(19) United States
(12) Patent Application Publication
(10) Pub. No.: US 2005/0030412 A1
(43) Pub. Date: Feb. 10, 2005

(54) Image correction processing method and image capture system using the same

(75) Inventor: Satoshi Nakayama, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/910,039

(22) Filed: Aug. 2, 2004

(30) Foreign Application Priority Data
Aug. 7, 2003 (JP) 2003-288864

(51) Int. Cl. H04N 5/235

(52) U.S. Cl. 348/362

(57) ABSTRACT

An image capture system having an image sensor for capturing an object image is disclosed. The image capture system includes a first correction circuit for correcting exposed-image data obtained from the image sensor with the image sensor in an exposed state on the basis of unexposed-image data obtained from the image sensor with the image sensor in an unexposed state, a second correction circuit for correcting a first signal included in the exposed-image data obtained from the image sensor by using a second signal included in the exposed-image data, and a control circuit for selecting, according to shooting conditions of the image capture system, one of the first correction circuit and the second correction circuit that applies correction to the exposed-image data obtained from the image sensor.

### BACKGROUND OF THE INVENTION

1. Field of the Invention

The present invention relates to an image capture system for capturing an object image.

2. Description of Related Art

Various image capture devices such as electronic cameras for recording a still image or for recording a moving video image captured via an image sensor such as a CCD (charge-coupled device) are capable of performing dark-noise correction processing. Dark-noise correction processing is an arithmetic operation using both dark image data and main shooting image data. Dark image data is read out after performing charge integration with the image sensor in an unexposed state and main shooting image data is read out after performing charge integration with the image sensor in an exposed state. By performing dark-noise correction processing, deterioration in image quality such as dark current noise occurring in the image sensor or minute flaws such as spot flaws caused by pixel defects inherent in the image sensor can be diminished.

In particular, since dark current noise increases with an increase in charge integration time (charge storage time) or an increase in temperature of the image sensor, dark-noise correction processing improves image quality when exposure occurs for a long integration time or when exposure is effected in a high-temperature environment. Accordingly, dark-noise correction processing is a significantly useful function for users of electronic cameras and the like.

In addition, with respect to the minute flaw caused by pixel defects inherent in the image sensor, some image capture systems are capable of performing flaw-correction interpolation processing. The flaw-correction interpolation processing is an arithmetic interpolation operation using image data of pixels adjacent to a flawed pixel to correct the flaw. The flaw-correction interpolation processing includes a method of detecting defective pixels and storing locations thereof in advance at the time of production process or power-on of the system and performing interpolation based on the location information, a method of discerning defective pixels on the basis of image information obtained during exposure and performing interpolation in real time, etc.

As discussed above, some image capture systems, such as electronic cameras, perform interpolation processing for defective pixels at all times. However, other image capture devices perform dark-noise correction processing in order to cope with the problem of increase in dark current noise and/or spot flaws.

FIG. 2 is a block diagram showing the components of a conventional image capture system 20. The conventional image capture system 20 includes a lens 200, an image sensor 201 such as a CCD, an analog front-end processor 202 containing an analog signal processing circuit using correlated double sampling and an A/D converter, a dark-noise correction circuit 204, an image memory 205, a defective-pixel detecting circuit 206, a pixel interpolation circuit 207, a signal processing circuit 209, a display device 210, and a storage medium 211 for storing image data. In the conventional image capture system 20, an object image formed on the image sensor 201 via the lens 200 is converted into an image signal. The image signal is supplied to the analog front-end processor 202. The analog front-end processor 202 performs correlated double sampling and A/D conversion on the image signal. Then, the defective-pixel detecting circuit 206 and the pixel interpolation circuit 207 in combination apply defective-pixel correction to the image signal from the analog front-end processor 202. Subsequently, the dark-noise correction circuit 204 and the image memory 205 in combination apply dark-noise correction to the image signal from the pixel interpolation circuit 207. The signal processing circuit 209 performs predetermined processing on the image signal from the dark-noise correction circuit 204. The display device 210 displays a still image or a moving video image represented by the image signal from the signal processing circuit 209. The storage medium 211 stores the image signal from the signal processing circuit 209 when an instruction for recording is given by the user.

However, the interpolation processing for defective pixels has a disadvantage in that frequency characteristic deteriorates because of use of surrounding pixels. Also, in the method of discerning defective pixels on the basis of image information obtained during exposure and performing interpolation in real time, it is possible that a high-frequency component of the signal obtained from a pixel other than defective pixels will be erroneously regarded as a defective pixel, thereby causing further deterioration in image quality.

Furthermore, dark-noise correction processing has a disadvantage in that there will be a time lag in shooting because a relatively long time is required for performing such processing.

Therefore, if the interpolation processing for defective pixels is performed at the same time as dark-noise correction processing, image quality may deteriorate beyond the effect of correcting for defective pixels (i.e., deterioration in image quality occurs due to overcorrection).

### SUMMARY OF THE INVENTION

The present invention addresses one or more of the foregoing related art disadvantages by providing a high quality image capture system. Among other advantages, the image capture system is capable of obtaining a high-quality image while preventing deterioration in image quality and occurrence of a time lag.

According to an aspect of the present invention, an image capture system having an image capture unit having a plurality of pixels for capturing an object image is provided. The image capture system comprises a first correction unit for correcting exposed-image data obtained from the image capture unit on the basis of unexposed-image data obtained from the image capture unit when the image capture unit was in an unexposed state, a second correction unit for correcting the exposed-image data of the pixel by using the exposed-image of the peripheral pixels included in the exposed-image data, and a control unit for selecting, according to shooting conditions of the image capture system, one of the first correction unit and the second correction unit that applies correction to the exposed-image data obtained from the image capture unit.

Other features and advantages of the present invention will become apparent to those skilled in the art upon reading of the following detailed description of embodiments thereof when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the components of an image capture system according to first and third embodiments of the invention.

FIG. 2 is a block diagram showing the components of a conventional image capture system.

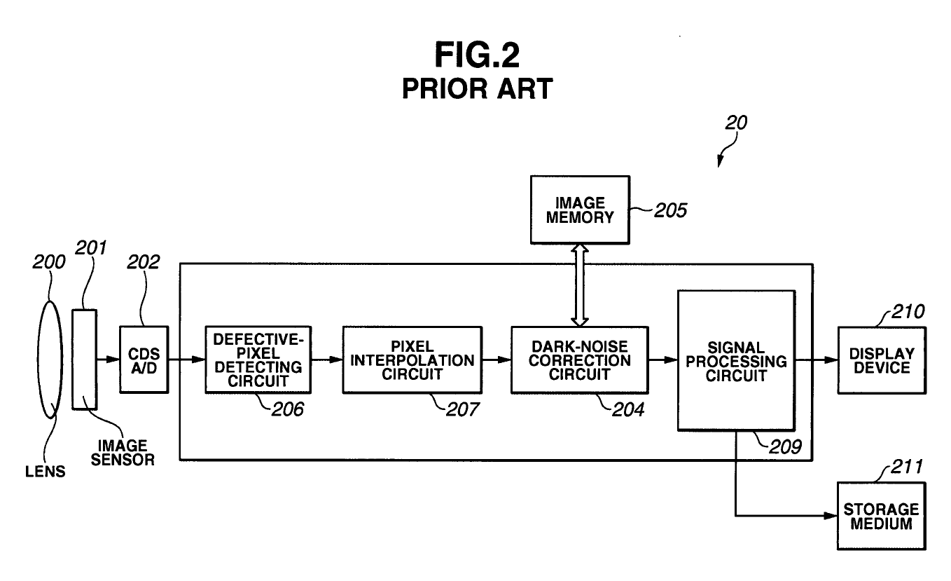

FIG. 3 is a block diagram showing the components of an image capture system according to second and fourth embodiments of the invention.

FIG. 4 is a diagram illustrating dark-noise correction processing.

FIG. 5 is a diagram illustrating defective-pixel correction processing.

FIG. 6 is a flow chart showing a method for implementing dark-noise correction or defective-pixel correction according to a first embodiment of the present invention.

FIG. 7 is a diagram illustrating defective-pixel correction processing according to the second embodiment of the invention.

FIG. 8 is a flow chart of a method for switching between dark-noise correction or defective-pixel correction based on the shooting conditions of an image capture system in accordance with a second embodiment of the present invention.

FIG. 9 is a flow chart of a method for switching between dark-noise correction or defective-pixel correction based on the shooting conditions of an image capture system in accordance with a third embodiment of the present invention.

FIG. 10 is a flow chart of a method for switching between dark-noise correction or defective-pixel correction based on the shooting conditions of an image capture system in accordance with a fourth embodiment of the present invention.

### DETAILED DESCRIPTION OF THE INVENTION

Embodiments of the invention will be described in detail below with reference to the drawings.

<First Embodiment>

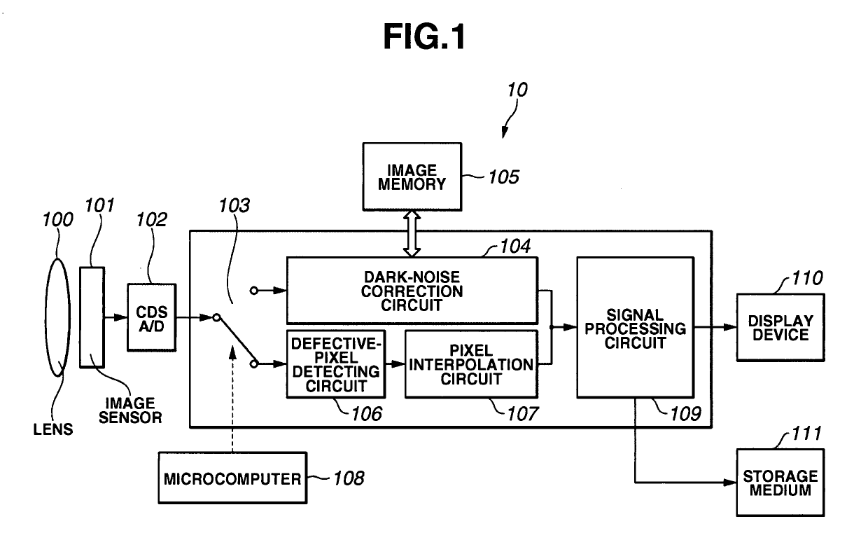

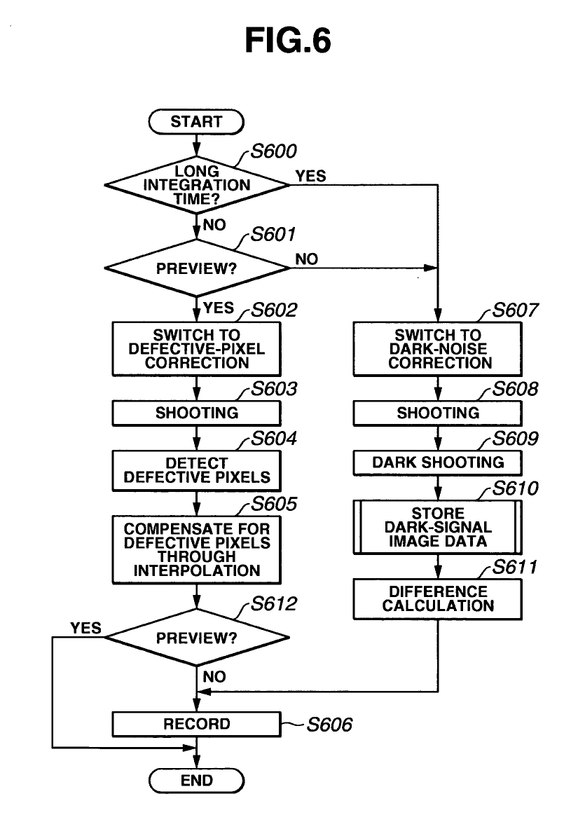

FIG. 1 is a diagram schematically showing an image capture system 10 according to a first embodiment of the invention. The image capture system 10 includes a lens 100, an image sensor 101 such as a CCD (Charge-Coupled Device), an analog front-end processor 102 containing an analog signal processing circuit using correlated double sampling and an A/D converter, an operation changeover switch 103, a dark-noise correction circuit 104, an image memory 105, a defective-pixel detecting circuit 106, a pixel interpolation circuit 107, a microcomputer 108, a signal processing circuit 109, a display device 110, and a storage medium 111 for storing image data. The microcomputer 108 controls the operation changeover switch 103 to switch between defective-pixel correction processing and dark-noise correction processing as further described with reference to at least FIG. 6.

Operation of the image capture system 10 as configured above according to the first embodiment is described as follows.

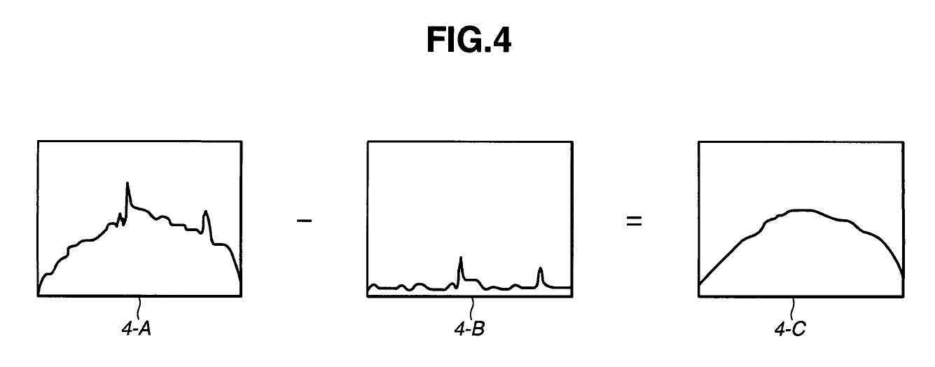

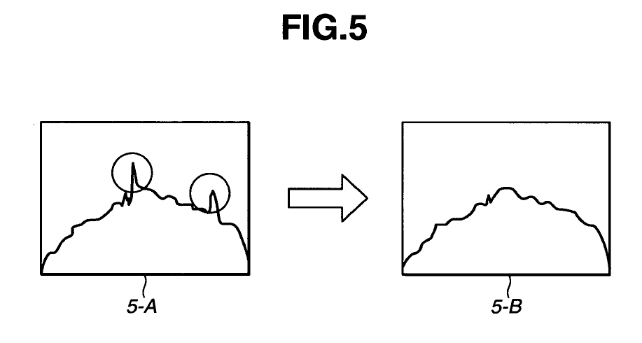

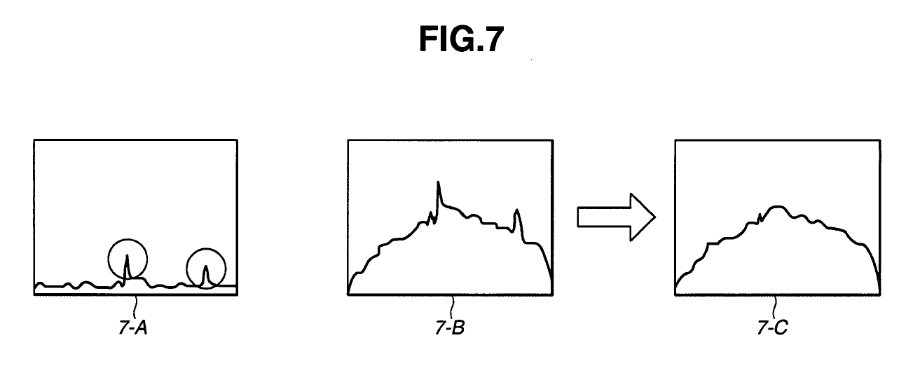

In the image capture system 10, an object image formed on the image sensor 101 via the lens 100 is converted into an image signal. The image signal is supplied to the analog front-end processor 102. The analog front-end processor 102 performs correlated double sampling and A/D conversion on the image signal. Then, the operation changeover switch 103 supplies the image signal from the front-end processor 102 selectively to one of the dark-noise correction circuit 104 and the defective-pixel detecting circuit 106 according to instructions from the microcomputer 108. The dark-noise correction circuit 104 in combination with the image memory 105 performs dark-noise correction processing on the image signal supplied from the operation changeover switch 103 as further described with reference to FIG. 4. The defective-pixel detecting circuit 106 and the pixel interpolation circuit 107 in combination perform defective-pixel correction processing on the image signal supplied from the operation changeover switch 103 as further described with reference to FIGS. 5 and 7. The signal processing circuit 109 performs predetermined processing on the image signal from the dark-noise correction circuit 104 or the pixel interpolation circuit 107. The display device 110 displays a still image or a moving video image represented by the image signal from the signal processing circuit 109. The storage medium 111 stores the image signal from the signal processing circuit 109 when an instruction for recording is given by the user.

FIG. 4 is a diagram illustrating dark-noise correction processing that is performed by the dark-noise correction circuit 104. In FIG. 4, reference character 4-A denotes an image signal captured with the image sensor 101 in an exposed state. Reference character 4-B denotes a dark signal captured with the image sensor 101 in an unexposed state. Reference character 4-C denotes a signal representing a difference between the captured image signal 4-A and the dark signal 4-B. In the case of an ideal image capture system, the dark signal 4-B should be in a no-signal state. In practice, however, the dark signal 4-B typically contains noise components, as shown in FIG. 4, under the influence of pixel defects, etc. Such noise components vary according to various conditions, for example, charge integration time. That is, the longer the charge integration time, the larger the noise components become. Therefore, it can be concluded that the captured image signal 4-A contains noise components based on the dark signal 4-B and a satisfactory-quality image cannot be obtained without correction. Accordingly, the dark-noise correction circuit 104 performs such an operation as to subtract the dark signal 4-B from the captured image signal 4-A to obtain a signal 4-C with noise components removed.

Operation of the defective-pixel detecting circuit 106 is now described as follows. It is assumed herein that there are defective pixels causing an undue increase in signal level of each pixel. FIG. 5 is a conceptual diagram illustrating defective-pixel correction processing performed by the defective-pixel detecting circuit 106 and the pixel interpolation circuit 107. In FIG. 5, reference character 5-A denotes a captured image signal. Reference character 5-B denotes an image signal obtained by compensating for defective pixels through interpolation. As shown in circled portions of the captured image signal 5-A, there are, in some cases, portions where the signal level of the corresponding pixel becomes higher than the original image signal level because of pixel defects. Such portions appear as white spot flaws on the displayed image. The defective-pixel detecting circuit 106 detects a defective pixel by comparing the signal level of each pixel of the image signal with signal levels of adjacent, surrounding pixels. In this regard, however, since the signal level of each pixel of the captured image signal is not constant but varies depending on the captured image, a defective pixel can be detected by averaging and comparing signal levels of surrounding pixels adjacent to that of the target pixel. The circled portions of the captured image signal 5-A can be detected in the above-described way. However, in the case of a captured image signal having such a high-frequency pattern that signal levels vary pixel by pixel, erroneous detection may occur. To prevent such erroneous detection, the signal level of the target pixel and those of the surrounding pixels are compared in order to discriminate between the signal level of the original image signal and the signal level of a defective pixel. Information on locations of the defective pixels as detected by the defective-pixel detecting circuit 106 in the above-described way is transmitted to the pixel interpolation circuit 107 for pixel interpolation.

Operation of the pixel interpolation circuit 107 is now described as follows. The pixel interpolation circuit 107 performs interpolation for defective pixels by compensating for each defective pixel detected by the defective-pixel detecting circuit 106 using the surrounding pixels. The manner of interpolation is classified into a number of methods according to how many of the surrounding pixels are used for interpolation. For example, one method refers to pixels arranged along the horizontal direction. Another method refers to those pixels arranged along the vertical direction and along the oblique directions, etc. In the case of a captured image signal having a high-frequency content such that signal levels vary pixel by pixel, interpolation for defective pixels may lead to deterioration in image quality because an image equivalent to the original image cannot be obtained. Therefore, it may be preferable to perform interpolation using pixels arranged along the vertical direction and along the oblique directions in addition to pixels arranged along the horizontal direction. As a result of the operation of the pixel interpolation circuit 107, white spot flaws are corrected as indicated by the image signal 5-B, which has no appreciable deterioration in image quality.

Nevertheless, various disadvantages associated with the above-described methods can be noted. The interpolation processing for defective pixels has a disadvantage in that frequency characteristic may deteriorate. Also, in the method of discerning defective pixels on the basis of image information obtained during exposure and performing interpolation in real time, a high-frequency component of the signal obtained from a pixel other than defective pixels may be erroneously regarded as a defective pixel, thereby causing further deterioration in image quality. And, dark-noise correction processing has a disadvantage in that a time lag in shooting exists because the dark signal is obtained with the image sensor 101 in an unexposed state for the same period of time as that for the main shooting image signal and a relatively long time is, therefore, required for performing such processing.

According to a first embodiment of the present invention, dark-noise correction and defective-pixel correction are mutually exclusively applied, so that an image capture system capable both of reducing time lag and obtaining high-quality images can be provided.

Since the dark current noise and/or spot flaws increase according to an increase in charge integration time or a rise in temperature of the image sensor, dark-noise correction processing is very effective when exposure is effected for a long integration time. On the other hand, when exposure is effected for a short integration so that when a moving image is captured, time lag becomes more conspicuous. Under this and other shooting conditions such as when previewing of a captured image is effected without performing recording thereof, defective-pixel correction is applied. Thus, in the first embodiment, either dark-noise correction processing or defective-pixel correction processing is selectively implemented based on shooting conditions of the image capture system 10.

The microcomputer 108 controls the operation changeover switch 103 for switching between dark-noise correction processing and defective-pixel correction processing. FIG. 6 is a flow chart showing a method for implementing dark-noise correction or defective-pixel correction according to a first embodiment of the present invention. In this exemplary embodiment, the method is executed by the microcomputer 108.

Referring to the flow chart of FIG. 6, a check is first made at step S600 to determine if the integration time is longer than a predetermined time length. If so, the flow proceeds to step S607 where dark-noise correction processing is implemented. An advantage of the present embodiment is that since dark current noise increases with charge integration time (charge storage time), dark-noise correction processing improves image quality when exposure occurs for a long integration time (more than a predetermined integration time). Therefore, dark-noise processing is selected for implementation as it is more beneficial compared to defective-pixel correction processing when the charge integration time is long. Referring back to FIG. 6, if the integration time is less than the predetermined time length, the flow proceeds to step S601. At step S601, a check is made to determine if the image capture system 10 is in the preview mode. If not, the flow proceeds to step S607 for switching to dark-noise correction processing. If so, the flow proceeds to step S602 for switching to defective-pixel correction processing, from which flow proceeds from step S602 to step S603, where shooting is performed. At step S604, the defective-pixel detecting circuit 106 detects defective pixels. At step S605, the pixel interpolation circuit 107 compensates for the detected defective pixels through interpolation to form a corrected image signal. At step S606, the corrected image signal is recorded in the storage medium 111, unless it is determined at step S612 that the image capture system 10 is still in the preview mode. On the other hand, for dark-noise correction processing, the flow proceeds from step S607 to step S608. At step S608, main shooting is performed. At step S609, dark shooting is performed. At step S610, a dark-signal image data obtained by the dark shooting is stored in the image memory 105. At step S611, the dark-noise correction circuit 104 calculates a difference between the dark-signal image data stored in the image memory 105 and image data captured by the main shooting to form a corrected, noise-removed image signal. Then, at step S606, the corrected image signal is recorded in the storage medium 111.

As described above, dark-noise correction and defective-pixel correction are mutually exclusively applied according to shooting conditions of the image capture system 10, such as whether the integration time is longer than a predetermined time length, whether the shooting is performed for capturing a still image or a moving video image, whether the image capture system 10 is in the preview mode, etc. Accordingly, since both advantages of the two types of image correction methods can be selected from, an image having little deterioration in image quality can be obtained. While, in the first embodiment, the integration time and the preview mode each are taken as an example of the shooting conditions of the image capture system 10, the two types of image correction methods may be switched over based on other conditions, such as recording of a moving video image, setting of gain or sensitivity during shooting, etc. Furthermore, while, in the first embodiment, defective-pixel correction processing is an interpolation operation using signals obtained from pixels surrounding a defective pixel, another correction operation, such as substituting a signal obtained from a pixel located above the defective pixel for a signal obtained from the defective pixel, may be employed. Also, dark-noise correction processing may be changed to a correction operation different from that described in the first embodiment.

<Second Embodiment>

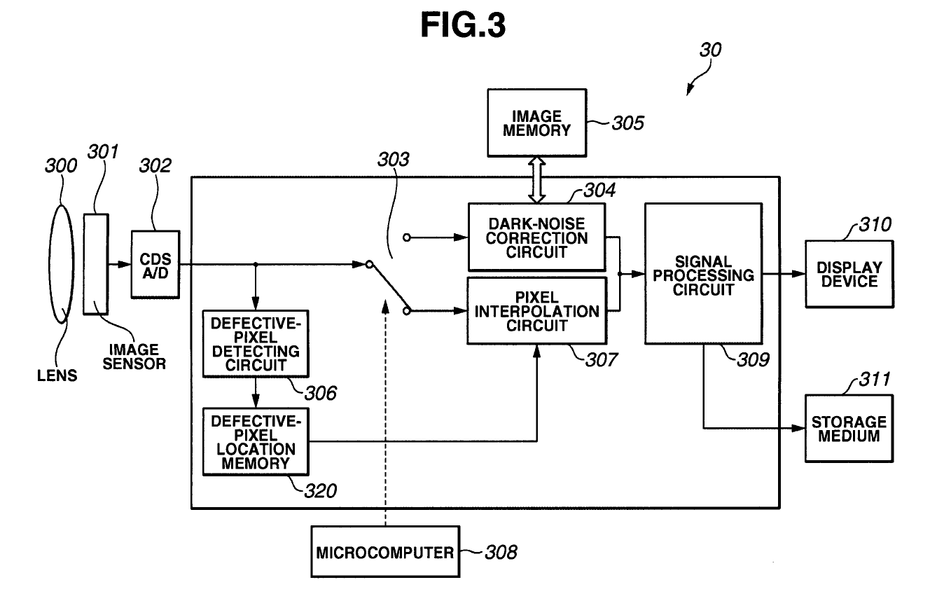

FIG. 3 is a block diagram showing the components of an image capture system 30 according to a second embodiment of the invention. The image capture system 30 includes a lens 300, an image sensor 301 such as a CCD, an analog front-end processor 302, an operation changeover switch 303, a dark-noise correction circuit 304, an image memory 305, a defective-pixel detecting circuit 306, a pixel interpolation circuit 307, a microcomputer 308, a signal processing circuit 309, a display device 310, and a storage medium 311, which are similar to the elements 100 to 111, respectively, shown in FIG. 1 for the first embodiment. The image capture system 30 further includes a defective-pixel location memory 320. The defective-pixel location memory 320 stores locations of defective pixels detected by the defective-pixel detecting circuit 306. The defective-pixel location memory 320 may be a volatile memory or a non-volatile memory according to the configuration of the image capture system 30. The non-volatile memory may be employed in cases where detection of defective pixels is performed during a factory calibration process. The volatile memory may be employed in cases where detection of defective pixels is performed during use of the image capture system 30, such as at the time of power-on of the image capture system 30.

Like the first embodiment, an object image formed on the image sensor 301 via the lens 300 is converted into an image signal. The image signal is supplied to the analog front-end processor 302. The analog front-end processor 302 performs correlated double sampling and A/D conversion on the image signal. Then, the operation changeover switch 303 supplies the image signal from the front-end processor 302 selectively to one of the dark-noise correction circuit 304 and the pixel interpolation circuit 307 according to instructions from the microcomputer 308. The dark-noise correction circuit 304 in combination with the image memory 305 performs dark-noise correction processing on the image signal supplied from the operation changeover switch 303. The pixel interpolation circuit 307 performs defective-pixel correction processing on the image signal supplied from the operation changeover switch 303, as described below with reference to FIG. 7. The signal processing circuit 309 performs predetermined processing on the image signal from the dark-noise correction circuit 304 or the pixel interpolation circuit 307. The display device 310 displays a still image or a moving video image represented by the image signal from the signal processing circuit 309. The storage medium 311 stores the image signal from the signal processing circuit 309 when an instruction for recording is given by the user. On the other hand, the image signal from the analog front-end processor 302 is also supplied to the defective-pixel detecting circuit 306. In the present embodiment, detection of defective pixels is not performed at the time of shooting and, therefore, the defective-pixel detecting circuit 306 operates when detection of defective pixels is performed.

Operation of the dark-noise correction circuit 304 is similar to that of the first embodiment. That is, the dark-noise correction circuit 304 calculates a difference between the captured image signal and the dark signal so as to obtain an image signal with noise components removed.

Operation of the defective-pixel detecting circuit 306 is now described as follows. It is assumed herein that there are defective pixels causing an undue increase in signal level of each pixel. There are, in some cases, portions where the signal level of a pixel in an originally dark portion becomes high because of pixel defects. Such portions appear as white spot flaws on the displayed image. The defective-pixel detecting circuit 306 detects a defective pixel by comparing the signal level of each pixel of an image signal obtained with the image sensor 301 in an unexposed state with signal levels of adjacent, surrounding pixels. In the case of the first embodiment, since defective pixels are detected from an image signal obtained at the time of shooting, erroneous detection may occur when the image signal has such a high-frequency pattern that signal levels vary pixel by pixel. On the other hand, in the second embodiment, since defective pixels are detected from an image signal obtained with the image sensor 301 in an unexposed state, detection can be made without being affected by a captured image signal. Locations in the image sensor 301 of defective pixels detected by the defective-pixel detecting circuit 306 are stored in the defective-pixel location memory 320.

In FIG. 7, reference character 7-A denotes an image signal obtained with the image sensor 301 in an unexposed state. The circled portions of the image signal 7-A are detected as defective pixels.

Operation of the pixel interpolation circuit 307 is described as follows. The pixel interpolation circuit 307 performs interpolation for defective pixels by compensating for each pixel corresponding to the defective-pixel location stored in the defective-pixel location memory 320 using the surrounding pixels. The manner of interpolation is similar to that of the first embodiment. Referring to FIG. 7, in an image signal 7-B containing defective pixels, defective-pixel portions are compensated for through interpolation with the surrounding pixels, so that an image signal 7-C of improved image quality can be obtained. As a result of the operation of the pixel interpolation circuit 307, white spot flaws are corrected and made inconspicuous similar to the image signal 5-B shown in FIG. 5.

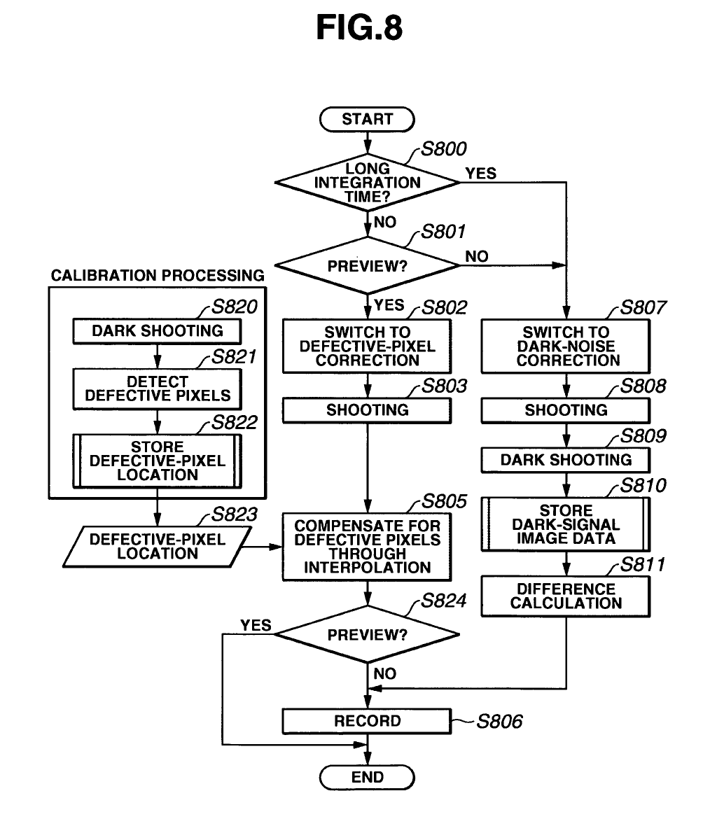

According to the second embodiment, two types of image correction methods, i.e., dark-noise correction and defective-pixel correction, are mutually exclusively applied as in the first embodiment, and are switched over according to a shooting condition of the image capture system 30. FIG. 8 is a flow chart of a method for switching between dark-noise correction or defective-pixel correction based on the shooting conditions of image capture system 30 in accordance with a second embodiment of the present invention. In this embodiment, the switching method is implemented by the microcomputer 308. A feature of the second embodiment is that calibration processing is performed in advance to store locations of defective pixels. In calibration processing, dark shooting is first performed at step S820. At the next step S821, defective pixels are detected from a dark signal obtained by the dark shooting. At step S822, locations of the detected defective pixels are stored in the defective-pixel location memory 320. Then, at step S823, the stored defective-pixel location information is supplied to the pixel interpolation circuit 307 at the time of shooting.

In operation during shooting, a check is first made at step S800 to determine if the integration time is longer than a predetermined time length. If so, the flow proceeds to step S807 for switching to dark-noise correction processing. If not, the flow proceeds to step S801. At step S801, a check is made to determine if the image capture system 30 is in the preview mode. If not, the flow proceeds to step S807 for switching to dark-noise correction processing. If so, the flow proceeds to step S802 for switching to defective-pixel correction processing, after which flow proceeds to step S803, where shooting is performed. At step S805, the pixel interpolation circuit 307 compensates for defective pixels through interpolation by referring to the stored defective-pixel location information so as to form a corrected image signal. At step S806, the corrected image signal is recorded in the storage medium 311, unless it is determined at step S824 that the image capture system 30 is still in the preview mode. On the other hand, in dark-noise correction processing, the flow proceeds from step S807 to step S808. At step S808, main shooting is performed. At step S809, dark shooting is performed. At step S810, a dark-signal image data obtained by the dark shooting is stored in the image memory 305. At step S811, the dark-noise correction circuit 304 calculates a difference between the dark-signal image data stored in the image memory 305 and image data captured by the main shooting to form a corrected, noise-removed image signal. Then, at step S806, the corrected image signal is recorded in the storage medium 311.

As described above, dark-noise correction and defective-pixel correction are mutually exclusively applied based on shooting conditions for image capture system 30, such as whether the integration time is longer than a predetermined time length, whether the image capture system 30 is in the preview mode, etc. Accordingly, since both advantages of the two types of image correction methods can be selected from, an image having little deterioration in image quality can be obtained. While, in the second embodiment, the integration time and the preview mode each are taken as an example of the shooting conditions of the image capture system 30, the two types of image correction methods may be switched over according to another operation condition, such as recording of a moving video image, setting of gain or sensitivity during shooting, etc. Furthermore, dark-noise correction processing or defective-pixel correction processing may be changed to a correction operation different from that described in the second embodiment. In addition, calibration processing may be performed in the factory or at the time of power-on of the image capture system 30, or immediately before power-off of the image capture system 30.

Furthermore, while the first embodiment has shown a configuration of performing defective-pixel correction processing in real time using a captured image signal and the second embodiment has shown a configuration of detecting defective pixels in advance and performing interpolation during shooting, another configuration of combining real-time detection of defective pixels and advance detection of defective pixels may be employed to ensure correction for defective pixels.

Even in such a configuration, dark-noise correction and defective-pixel correction are mutually exclusively applied according to shooting conditions of an image capture system, such as whether the integration time is longer than a predetermined time length, whether the image capture system is in the preview mode, etc. Accordingly, since both advantages of the two types of image correction methods can be selected from, an image having little deterioration in image quality can be obtained.

The present invention is not limited to the above embodiments and various changes and modifications can be made within the spirit and scope of the present invention.

<Third Embodiment>

Operation of the image capture system 10 as configured according to the third embodiment is described as follows.

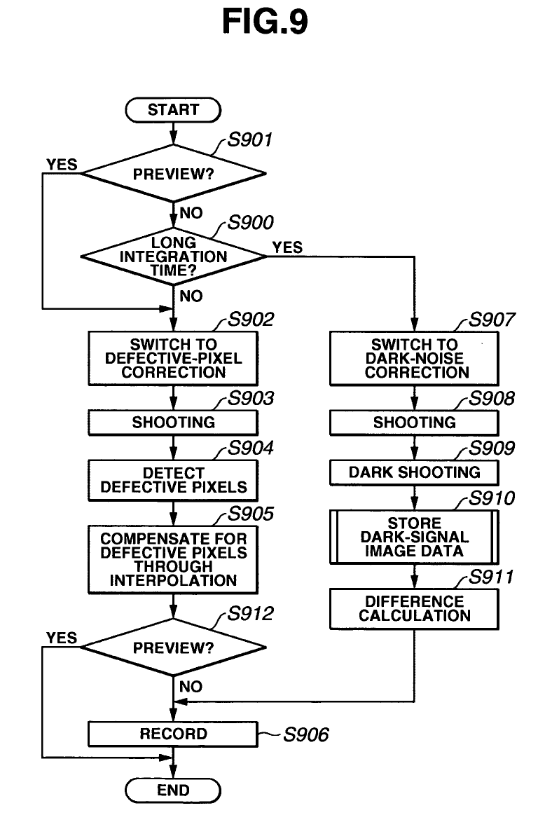

According to the third embodiment, two types of image correction methods, i.e., dark-noise correction and defective-pixel correction, are mutually exclusively applied, as in the first embodiment, and are switched over according to shooting conditions of the image capture system 10. FIG. 9 is a flow chart of a method for switching between dark-noise correction or defective-pixel correction based on the shooting conditions of image capture system 30 in accordance with a third embodiment of the present invention. In this embodiment, the switching method is implemented by the microcomputer 108.

Referring to the flow chart of FIG. 9, a check is first made at step S901 to determine if the image capture system 10 is in the preview mode. If not, the flow proceeds to step S900. If so, the flow proceeds to step S902 for switching to defective-pixel correction processing. At step S900, a check is made to determine if the integration time is longer than a predetermined time length. If so, the flow proceeds to step S907 for switching to dark-noise correction processing. If not, the flow proceeds to step S902 for switching to defective-pixel correction processing. In defective-pixel correction processing, the flow proceeds from step S902 to step S903, where shooting is performed. At step S904, the defective-pixel detecting circuit 106 detects defective pixels. At step S905, the pixel interpolation circuit 107 compensates for the detected defective pixels through interpolation to form a corrected image signal. At step S906, the corrected image signal is recorded in the storage medium 111, unless it is determined at step S912 that the image capture system 10 is still in the preview mode. On the other hand, in dark-noise correction processing, the flow proceeds from step S907 to step S908. At step S908, main shooting is performed. At step S909, dark shooting is performed. At step S910, a dark-signal image data obtained by the dark shooting is stored in the image memory 105. At step S911, the dark-noise correction circuit 104 calculates a difference between the dark-signal image data stored in the image memory 105 and image data captured by the main shooting to form a corrected, noise-removed image signal. Then, at step S906, the corrected image signal is recorded in the storage medium 111.

As described above, dark-noise correction and defective-pixel correction are mutually exclusively applied according to shooting conditions of the image capture system 10, such as whether the integration time is longer than a predetermined time length, whether the image capture system 10 is in the preview mode, etc. Accordingly, since both advantages of the two types of image correction methods can be selected from, an image having little deterioration in image quality can be obtained. While, in the first embodiment, the integration time and the preview mode each are taken as an example of the shooting conditions of the image capture system 10, the two types of image correction methods may be switched over according to another operation condition, such as whether the shooting conditions is performed for capturing a still image or a moving video image, recording of a moving video image, setting of gain or sensitivity during shooting, etc. Furthermore, while, in the first embodiment, defective-pixel correction processing is an interpolation operation using signals obtained from pixels surrounding a defective pixel, another correction operation, such as substituting a signal obtained from a pixel located above the defective pixel for a signal obtained from the defective pixel, may be employed. Also, dark-noise correction processing may be changed to a correction operation different from that described in the first embodiment.

<Fourth Embodiment>

Operation of the image capture system 10 as configured according to the fourth embodiment is described as follows.

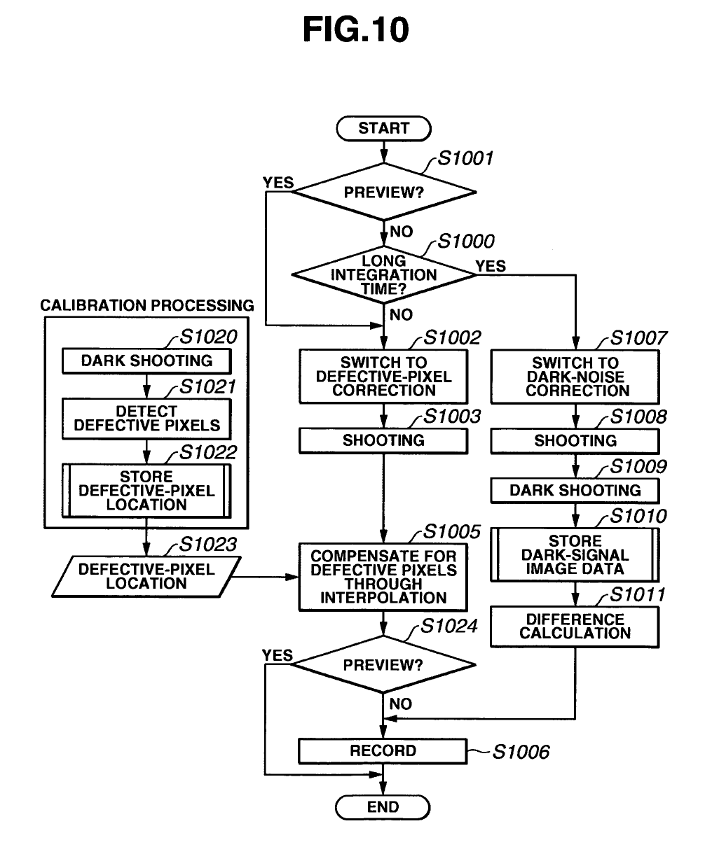

According to the fourth embodiment, two types of image correction methods, i.e., dark-noise correction and defective-pixel correction, are mutually exclusively applied, as in the second embodiment, and are switched over according to shooting conditions of the image capture system 30. FIG. 10 is a flow chart of a method for switching between dark-noise correction or defective-pixel correction based on the shooting conditions of image capture system 30 in accordance with the fourth embodiment of the present invention. In this embodiment, the switching method is implemented by the microcomputer 308. Features of the fourth embodiment lie in that calibration processing is performed in advance to store locations of defective pixels. In the calibration processing, dark shooting is first performed at step S1020. At the next step S1021, defective pixels are detected from a dark signal obtained by the dark shooting. At step S1022, locations of the detected defective pixels are stored in the defective-pixel location memory 320. Then, at step S1023, the stored defective-pixel location information is supplied to the pixel interpolation circuit 307 at the time of shooting.

In operation during shooting, a check is first made at step S1001 to determine if the image capture system 30 is in the preview mode. If not, the flow proceeds to step S1000. If so, the flow proceeds to step S1002 for switching to defective-pixel correction processing. At step S1000, a check is made to determine if the integration time is longer than a predetermined time length. If so, the flow proceeds to step S1007 for switching to dark-noise correction processing. If not, the flow proceeds to step S1002 for switching to defective-pixel correction processing. In defective-pixel correction processing, the flow proceeds from step S1002 to step S1003, where shooting is performed. At step S1005, the pixel interpolation circuit 307 compensates for defective pixels through interpolation by referring to the stored defective-pixel location information so as to form a corrected image signal. At step S1006, the corrected image signal is recorded in the storage medium 311, unless it is determined at step S824 that the image capture system 30 is still in the preview mode. On the other hand, in dark-noise correction processing, the flow proceeds from step S1007 to step S1008. At step S1008, main shooting is performed. At step S1009, dark shooting is performed. At step S1010, a dark-signal image data obtained by the dark shooting is stored in the image memory 305. At step S1011, the dark-noise correction circuit 304 calculates a difference between the dark-signal image data stored in the image memory 305 and image data captured by the main shooting to form a corrected, noise-removed image signal. Then, at step S1006, the corrected image signal is recorded in the storage medium 311.

As described above, dark-noise correction and defective-pixel correction are mutually exclusively applied based on shooting conditions of the image capture system 30, such as whether the integration time is longer than a predetermined time length, or whether the image capture system 30 is in the preview mode, etc. Accordingly, since both advantages of the two types of image correction methods can be selected from, an image having little deterioration in image quality can be obtained. While in the second embodiment, integration time and the preview mode are provided as examples of shooting conditions, other conditions consistent with the present invention are applicable. For example, as another shooting condition is whether the shooting is performed for capturing a still image or a moving video image. Yet, another example is whether the shooting is for recording of a moving video image. Other examples can be found. Furthermore, dark-noise correction processing or defective-pixel correction processing may be changed to a correction operation different from that described in the second embodiment. In addition, the calibration processing may be performed at power-on or immediately before power-off during a factory calibration process.

The present invention is not limited to the above embodiments and various changes and modifications can be made within the spirit and scope of the present invention. Therefore, to apprise the public of the scope of the present invention, the following claims are made.

This application claims priority from Japanese Patent Application No. 2003-288864 filed Aug. 7, 2003, which is hereby incorporated by reference herein.

1. An image capture system having an image capture unit having a plurality of pixels for capturing an object image, comprising:
a first correction unit for correcting exposed-image data obtained from the image capture unit on the basis of unexposed-image data obtained from the image capture unit when the image capture unit was in an unexposed state;
a second correction unit for correcting the exposed-image data of a pixel by using the exposed-image of peripheral pixels; and
a control unit for selecting any one of the first correction unit and the second correction unit to apply correction to the exposed-image data based on one or more shooting conditions of the image capture system.

2. An image capture system according to claim 1, wherein the shooting conditions include the exposure time length for the image capture unit.

3. An image capture system according to claim 1, wherein the shooting conditions include whether a still image or moving image is being shot.

4. An image capture system according to claim 1, wherein the shooting conditions include whether the exposed-image data obtained from the image capture unit is to be recorded.

5. A control method for an image sensing system having an image capture unit having a plurality of pixels for capturing an object image, characterized by comprising:
performing a first operation, wherein said the first operation is correcting exposed-image data obtained from the image capture unit with the image capture unit in an exposed state on the basis of unexposed-image data obtained from the image capture unit with the image capture unit in an unexposed state;
performing a second operation, wherein said the second operation is correcting the exposed-image data of the pixel by using the exposed-image of the peripheral pixels; and
performing a third operation, wherein the third operation is selecting according to a difference in shooting operation of the image capture system, one of the first operation and the second operation that applies correction to the exposed-image data obtained from the image capture unit.

6. An image capture system according to claim 1, further comprising an image-taking lens for forming an image on the image capture unit, an analog-to-digital converter for performing analog-to-digital conversion on a signal output from the image capture unit and transferring the converted signal to one of the first correction unit and the second correction unit.

7. A method of capturing an image, the method comprising:
providing a first correction unit capable of providing dark-noise correction to an image captured by an image capture unit;
providing a second correction unit capable of providing pixel-defect correction to the captured image; and
selecting either the first correction unit or the second correction unit for use with the image capture unit based on whether a charge integration time associated with the image capture unit is longer than a predetermined time length.
